(19) United States
(12) Patent Application Publication
(10) Pub. No.: US 2015/0097786 A1
(43) Pub. Date: Apr. 9, 2015

(54) DISPLAY APPARATUS

(71) Applicant: Nokia Corporation, Espoo (FI)

(72) Inventors: Thorsten Behles, Kangasala (FI); Marko Tapani Yliaho, Tampere (FI); Jouko Sormunen, Espoo (FI)

(21) Appl. No.: 14/400,651

(22) PCT Filed: May 31, 2012
(86) PCT No.: PCT/IB2012/052748

§ 371 Date: Nov. 12, 2014

(51) Int. Cl. G06F 3/01

(52) U.S. Cl. CPC G06F 3/016
USPC 345/173

(57) ABSTRACT

An apparatus comprising: a haptic profile determiner configured to determine a haptic profile map for a display; a touch event determiner configured to determine a touch event on the display within the area defined by the haptic profile map; and a haptic effect generator configured to generate a haptic effect on the display based on the touch event such that the haptic effect provides a simulated surface experience.

### FIELD

The present invention relates to a providing tactile functionality. The invention further relates to, but is not limited to, display apparatus providing tactile functionality for use in mobile devices.

### BACKGROUND

Many portable devices, for example mobile telephones, are equipped with a display such as a glass or plastic display window for providing information to the user. Furthermore such display windows are now commonly used as touch sensitive inputs. The use of a touch sensitive input with the display has the advantage over a mechanical keypad in that the display may be configured to show a range of different inputs depending on the operating mode of the device. For example, in a first mode of operation the display may be enabled to enter a phone number by displaying a simple numeric keypad arrangement and in a second mode the display may be enabled for text input by displaying an alphanumeric display configuration such as a simulated Qwerty keyboard display arrangement.

The display such as glass or plastic is typically static in that although the touch screen can provide a global haptic feedback simulating a button press by use of a vibra it does not simulate features shown on the display. In other words any tactile feedback is not really localised as the whole display or device vibrates and the display is unable to provide a different sensation other than that of glass or plastic.

### Statement

According to an aspect, there is provided a method comprising: determining a haptic profile map for a display; determining a touch event on the display within the area defined by the haptic profile map; and generating a haptic effect on the display based on the touch event such that the haptic effect provides a simulated surface experience.

Generating the haptic effect may be based on the touch event and the haptic profile map.

Determining a haptic profile map may comprise at least one of: generating a haptic profile map for the display; and loading a haptic profile map for the display.

The haptic profile map may comprise at least one of: at least one base haptic signal; at least one displacement signal modification factor; at least one directional signal modification factor; a speed signal modification factor; a touch period modification factor; and a force signal modification factor.

Determining a touch event may comprise at least one of: determining at least one touch position; determining at least one touch direction; determining at least one touch speed; determining at least one touch period; and determining at least one touch force.

Determining a haptic profile map may comprise determining a haptic profile map dependent on a previous touch event.

Determining a touch event may comprise determining at least one of: a hover touch over the display; and a contact touch physically in contact with the display.

The method may further comprise displaying an image on the display, wherein determining the haptic profile map for the display may comprise determining a haptic profile map associated with the image.

The method may further comprise modifying the image on the display dependent on the touch event on the display.

Generating a haptic effect on the display may comprise at least one of: actuating the display by at least one piezoelectric actuator located underneath and in contact with the display; and actuating an apparatus comprising the display by at least one vibra actuator located within the apparatus.

The method may further comprise generating an acoustic effect on the display based on the touch event such that the acoustic effect further provides the simulated surface experience.

According to a second aspect there is provided apparatus comprising at least one processor and at least one memory including computer code for one or more programs, the at least one memory and the computer code configured to with the at least one processor cause the apparatus to at least perform: determining a haptic profile map for a display; determining a touch event on the display within the area defined by the haptic profile map; and generating a haptic effect on the display based on the touch event such that the haptic effect provides a simulated surface experience.

Generating the haptic effect may cause the apparatus to generate the haptic effect based on the touch event and the haptic profile map.

Determining a haptic profile map may cause the apparatus to perform at least one of: generating a haptic profile map for the display; and loading a haptic profile map for the display.

The haptic profile map may comprise at least one of: at least one base haptic signal; at least one displacement signal modification factor; at least one directional signal modification factor; a speed signal modification factor; a touch period modification factor; and a force signal modification factor.

Determining a touch event may cause the apparatus to perform at least one of: determining at least one touch position; determining at least one touch direction; determining at least one touch speed; determining at least one touch period; and determining at least one touch force.

Determining a haptic profile map may cause the apparatus to perform determining a haptic profile map dependent on a previous touch event.

Determining a touch event may cause the apparatus to perform determining at least one of: a hover touch over the display; and a contact touch physically in contact with the display.

The apparatus may further perform displaying an image on the display, wherein determining the haptic profile map for the display causes the apparatus to perform determining a haptic profile map associated with the image.

The apparatus may further perform modifying the image on the display dependent on the touch event on the display.

Generating a haptic effect on the display causes the apparatus to perform actuating the display by at least one piezoelectric actuator located underneath and in contact with the display.

Generating a haptic effect on the display causes the apparatus to perform actuating an apparatus comprising the display by at least one vibra actuator located within the apparatus.

The apparatus may be caused to perform generating an acoustic effect on the display based on the touch event such that the acoustic effect further provides the simulated surface experience.

According to third aspect there is provided an apparatus comprising: means for determining a haptic profile map for a display; means for determining a touch event on the display within the area defined by the haptic profile map; and means for generating a haptic effect on the display based on the touch event such that the haptic effect provides a simulated surface experience.

The means for generating the haptic effect may generate the haptic effect based on the touch event and the haptic profile map.

The means for determining a haptic profile map may comprise at least one of: means for generating a haptic profile map for the display; and means for loading a haptic profile map for the display.

The haptic profile map may comprise at least one of: at least one base haptic signal; at least one displacement signal modification factor; at least one directional signal modification factor; a speed signal modification factor; a touch period modification factor; and a force signal modification factor.

The means for determining a touch event may comprise at least one of: means for determining at least one touch position; means for determining at least one touch direction; means for determining at least one touch speed; means for determining at least one touch period; and means for determining at least one touch force.

The means for determining a haptic profile map may comprise means for determining a haptic profile map dependent on a previous touch event.

The means for determining a touch event may comprise means for determining at least one of: a hover touch over the display; and a contact touch physically in contact with the display.

The apparatus may further perform means for displaying an image on the display, wherein the means for determining the haptic profile map for the display comprises means for determining a haptic profile map associated with the image.

The apparatus may further comprise means for modifying the image on the display dependent on the touch event on the display.

The means for generating a haptic effect on the display comprises means for actuating the display by at least one piezoelectric actuator located underneath and in contact with the display.

The means for generating a haptic effect on the display comprises means for actuating an apparatus comprising the display by at least one vibra actuator located within the apparatus.

The apparatus may comprise means for generating an acoustic effect on the display based on the touch event such that the acoustic effect further provides the simulated surface experience

According to a fourth aspect there is provided an apparatus comprising: a haptic profile determiner configured to determine a haptic profile map for a display; a touch event determiner configured to determine a touch event on the display within the area defined by the haptic profile map; and a haptic effect generator configured to generate a haptic effect on the display based on the touch event such that the haptic effect provides a simulated surface experience.

The haptic effect generator may be configured to generate the haptic effect based on the touch event and the haptic profile map.

The haptic effect determiner may comprise at least one of: a haptic profile map generator configured to generate a haptic profile map for the display; and a haptic profile map input configured to load a haptic profile map for the display.

The haptic profile map may comprise at least one of: at least one base haptic signal; at least one displacement signal modification factor; at least one directional signal modification factor; a speed signal modification factor; a touch period modification factor; and a force signal modification factor.

The touch event determiner may comprise at least one of: a touch position determiner configured to determine at least one touch position; a touch direction determiner configured to determine at least one touch direction; a touch speed determiner configured to determine at least one touch speed; a touch duration timer configured to determine at least one touch period; and a touch force determiner configured to determine at least one touch force.

The haptic profile map determiner may comprise a touch event state machine configured to determine a haptic profile map dependent on a previous touch event.

The touch event determiner may comprise at least one of: a hover touch determiner configured to determine touch over the display; and a contact touch determiner configured to determine touch physically in contact with the display.

The apparatus may further comprise a display configured to display an image, wherein the haptic profile map determiner comprises an image based haptic map determiner configured to determine a haptic profile map associated with the image.

The apparatus may further comprise a display processor configured to modify the image on the display dependent on the touch event.

The apparatus may comprise at least one piezoelectric actuator located underneath and in contact with the display and the haptic effect generator may be configured to control the actuator to actuate the display.

The apparatus may comprise at least one vibra actuator located within the apparatus and the haptic effect generator may be configured to control the actuator to actuate the display.

The apparatus may further comprise an acoustic effect generator configured to generate an acoustic effect on the display based on the touch event such that the acoustic effect further provides the simulated surface experience

A computer program product stored on a medium for causing an apparatus to may perform the method as described herein.

An electronic device may comprise apparatus as described herein.

A chipset may comprise apparatus as described herein.

### SUMMARY OF FIGURES

For better understanding of the present invention, reference will now be made by way of example to the accompanying drawings in which:

FIG. 1 shows schematically an apparatus suitable for employing some embodiments;

FIG. 2 shows schematically an example tactile audio display with transducer suitable for implementing some embodiments;

FIG. 3 shows schematically tactile effect generation system apparatus with multiple piezo actuators according to some embodiments;

FIG. 4 shows schematically a tactile effect generator system apparatus with separate amplifier channels according to some embodiments;

FIG. 5 shows schematically a tactile effect generator system apparatus incorporating a force sensor according to some embodiments;

FIG. 6 shows schematically a tactile effect generator system apparatus incorporating an audio output according to some embodiments;

FIG. 7 shows a flow diagram of the operation of the touch effect generation system apparatus with respect to a general tactile effect according to some embodiments;

FIG. 8 shows schematically a touch controller as shown in the tactile effect generator system apparatus from FIGS. 4 to 7 according to some embodiments;

FIG. 9 shows schematically a tactile effect generator as shown in the tactile effect generator system apparatus from FIGS. 4 to 7 according to some embodiments;

FIG. 10 shows a flow diagram of the operation of the touch controller shown in FIG. 8 according to some embodiments;

FIG. 11 shows a flow diagram of the operation of the tactile effect generator as shown in FIG. 9 according to some embodiments;

FIG. 12 shows a further flow diagram of the operation of the tactile effect generator as shown in FIG. 9 according to some embodiments;

FIG. 13 shows an example cardboard simulation texture display for the tactile audio display according to some embodiments;

FIG. 14 shows the directionality of an example cardboard simulation texture display for the tactile audio display according to some embodiments;

FIG. 15 shows an example fur simulation texture display for the tactile audio display according to some embodiments;

FIG. 16 shows an example alien metal simulation texture display for the tactile audio display according to some embodiments;

FIG. 17 shows an example roof tile simulation texture display for the tactile audio display according to some embodiments;

FIG. 18 shows an example soapy glass simulation texture display for the tactile audio display according to some embodiments;

FIG. 19 shows an example sand simulation texture display for the tactile audio display according to some embodiments;

FIG. 20 shows an example brushed metal simulation texture display for the tactile audio display according to some embodiments;

FIG. 21a shows an example wavy glass simulation texture display for the tactile audio display according to some embodiments;

FIG. 21b shows the tactile zones implementing the example wavy glass simulation according to some embodiments;

FIG. 22 shows an example rubber band simulation for the tactile audio display according to some embodiments;

FIG. 23 shows an example zoom touch simulation for the tactile audio display according to some embodiments;

FIG. 24 shows an example rotation touch simulation for the tactile audio display according to some embodiments;

FIG. 25 shows an example swipe gesture simulation for the tactile audio display according to some embodiments; and

FIG. 26 shows an example drag and drop user interface simulation for the tactile audio display according to some embodiments.

### DESCRIPTION OF EXAMPLE EMBODIMENTS

The application describes apparatus and methods capable of generating, encoding, storing, transmitting and outputting tactile and acoustic outputs from a touch screen device.

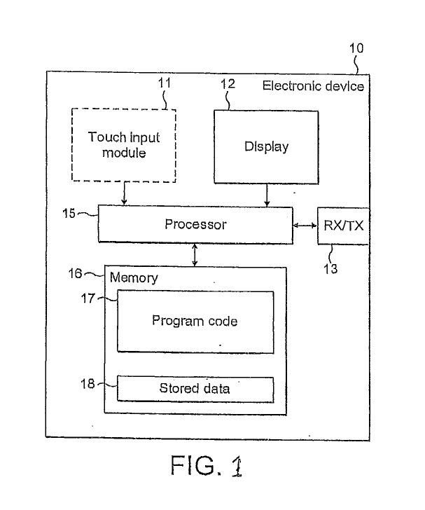

With respect to FIG. 1 a schematic block diagram of an example electronic device 10 or apparatus on which embodiments of the application can be implemented. The apparatus 10 is such embodiments configured to provide improved tactile and acoustic wave generation.

The apparatus 10 is in some embodiments a mobile terminal, mobile phone or user equipment for operation in a wireless communication system. In other embodiments, the apparatus is any suitable electronic device configured to provide an image display, such as for example a digital camera, a portable audio player (mp3 player), a portable video player (mp4 player). In other embodiments the apparatus can be any suitable electronic device with touch interface (which may or may not display information) such as a touch-screen or touch-pad configured to provide feedback when the touch-screen or touch-pad is touched. For example in some embodiments the touch-pad can be a touch-sensitive keypad which can in some embodiments have no markings on it and in other embodiments have physical markings or designations on the front window. An example of such a touch sensor can be a touch sensitive user interface to replace keypads in automatic teller machines (ATM) that does not require a screen mounted underneath the front window projecting a display. The user can in such embodiments be notified of where to touch by a physical identifier—such as a raised profile, or a printed layer which can be illuminated by a light guide.

The apparatus 10 comprises a touch input module or user interface 11, which is linked to a processor 15. The processor 15 is further linked to a display 12. The processor 15 is further linked to a transceiver (TX/RX) 13 and to a memory 16.

In some embodiments, the touch input module 11 and/or the display 12 are separate or separable from the electronic device and the processor receives signals from the touch input module 11 and/or transmits and signals to the display 12 via the transceiver 13 or another suitable interface. Furthermore in some embodiments the touch input module 11 and display 12 are parts of the same component. In such embodiments the touch interface module 11 and display 12 can be referred to as the display part or touch display part.

The processor 15 can in some embodiments be configured to execute various program codes. The implemented program codes, in some embodiments can comprise such routines as touch processing, input simulation, or tactile effect simulation code where the touch input module inputs are detected and processed, effect feedback signal generation where electrical signals are generated which when passed to a transducer can generate tactile or haptic feedback to the user of the apparatus, or actuator processing configured to generate an actuator signal for driving an actuator. The implemented program codes can in some embodiments be stored for example in the memory 16 and specifically within a program code section 17 of the memory 16 for retrieval by the processor 15 whenever needed. The memory 15 in some embodiments can further provide a section 18 for storing data, for example data that has been processed in accordance with the application, for example pseudo-audio signal data.

The touch input module 11 can be in some embodiments implement any suitable touch screen interface technology. For example in some embodiments the touch screen interface can comprise a capacitive sensor configured to be sensitive to the presence of a finger above or on the touch screen interface. The capacitive sensor can comprise an insulator (for example glass or plastic), coated with a transparent conductor (for example indium tin oxide—ITO). As the human body is also a conductor, touching the surface of the screen results in a distortion of the local electrostatic field, measurable as a change in capacitance. Any suitable technology may be used to determine the location of the touch. The location can be passed to the processor which may calculate how the user's touch relates to the device. The insulator protects the conductive layer from dirt, dust or residue from the finger.

In some other embodiments the touch input module can be a resistive sensor comprising of several layers of which two are thin, metallic, electrically conductive layers separated by a narrow gap. When an object, such as a finger, presses down on a point on the panel's outer surface the two metallic layers become connected at that point: the panel then behaves as a pair of voltage dividers with connected outputs. This physical change therefore causes a change in the electrical current which is registered as a touch event and sent to the processor for processing.

In some other embodiments the touch input module can further determine a touch using technologies such as visual detection for example a camera either located below the surface or over the surface detecting the position of the finger or touching object, projected capacitance detection, infra-red detection, surface acoustic wave detection, dispersive signal technology, and acoustic pulse recognition. In some embodiments it would be understood that ‘touch’ can be defined by both physical contact and ‘hover touch’ where there is no physical contact with the sensor but the object located in close proximity with the sensor has an effect on the sensor.

The apparatus 10 can in some embodiments be capable of implementing the processing techniques at least partially in hardware, in other words the processing carried out by the processor 15 may be implemented at least partially in hardware without the need of software or firmware to operate the hardware.

The transceiver 13 in some embodiments enables communication with other electronic devices, for example in some embodiments via a wireless communication network.

The display 12 may comprise any suitable display technology. For example the display element can be located below the touch input module and project an image through the touch input module to be viewed by the user. The display 12 can employ any suitable display technology such as liquid crystal display (LCD), light emitting diodes (LED), organic light emitting diodes (OLED), plasma display cells, Field emission display (FED), surface-conduction electron-emitter displays (SED), and Electrophoretic displays (also known as electronic paper, e-paper or electronic ink displays). In some embodiments the display 12 employs one of the display technologies projected using a light guide to the display window. As described herein the display 12 in some embodiments can be implemented as a physical fixed display. For example the display can be a physical decal or transfer on the front window. In some other embodiments the display can be located on a physically different level from the rest of the surface, such a raised or recessed marking on the front window. In some other embodiments the display can be a printed layer illuminated by a light guide under the front window

The concept of the embodiments described herein is to implement simulated experiences using the display and tactile outputs and in some embodiments display, tactile and audio outputs. In some embodiments the simulated experiences are simulations of textures or mechanical features represented on the display using tactile effects. Furthermore these tactile effects can be employed for any suitable haptic feedback wherein an effect is associated with a suitable display output characteristic. For example an effect can be associated with the profile of the simulated texture.

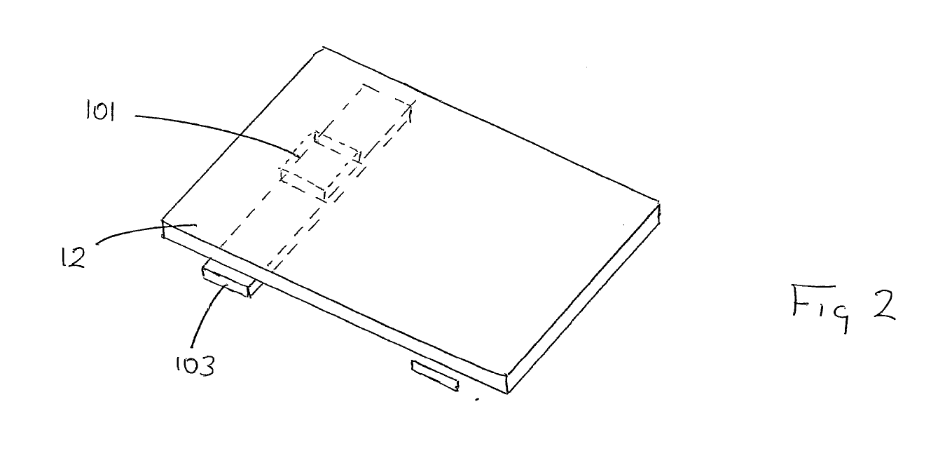

An example tactile audio display component comprising the display and tactile feedback generator is shown in FIG. 2. FIG. 2 specifically shows the touch input module 11 and display 12 under which is coupled a pad 101 which can be driven by the transducer 103 located underneath the pad. The motion of the transducer 103 can then be passed through the pad 101 to the display 12 which can then be felt by the user. The transducer or actuator 103 can in some embodiments be a piezo or piezo electric transducer configured to generate a force, such as a bending force when a current is passed through the transducer.

This bending force is thus transferred via the pad 101 to the display 12. It would be understood that in other embodiments the arrangement, structure or configuration of the tactile audio display component can be any suitable coupling between the transducer (such as a piezo-electric transducer) and the display.

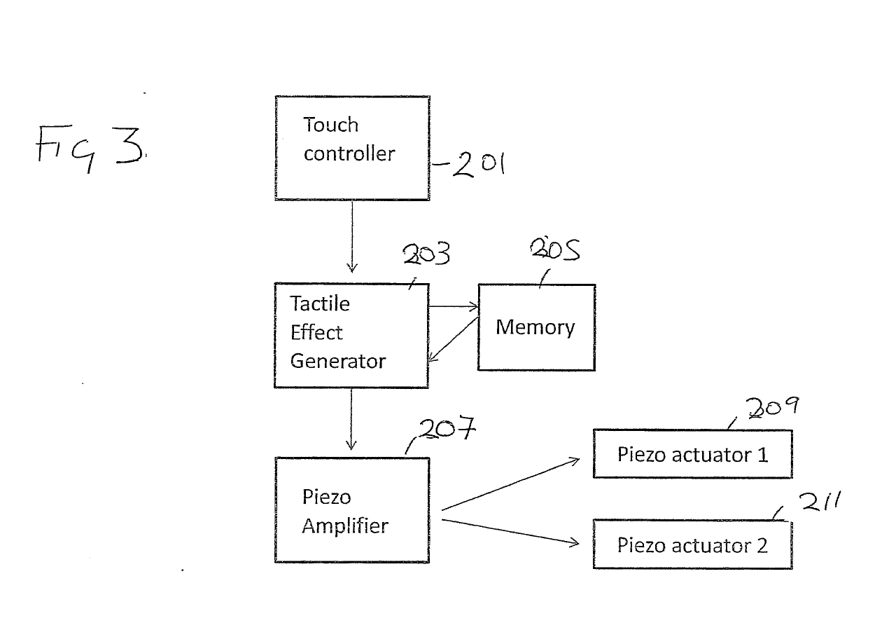

With respect to FIGS. 3 to 6 suitable tactile effects generator system apparatus are described with respect to embodiments of the application.

With respect to FIG. 3 a first tactile effect generator system apparatus is described. In some embodiments the apparatus comprise a touch controller 201.

The touch controller 201 can be configured to receive input from the tactile audio display or touch screen. The touch controller 201 can then be configured to process these inputs to generate suitable digital representations or characteristics associated with the touch such as: number of touch inputs; location of touch inputs; size of touch inputs; shape of touch input; position relative to other touch inputs; etc. The touch controller 201 can output the touch input parameters to a tactile effect generator 203.

In some embodiments the apparatus comprises a tactile effect generator 203, which can be implemented as an application process engine or suitable tactile effect means. The tactile effect generator 203 is configured to receive the touch parameters from the touch controller 201 and process the touch parameters to determine whether or not a tactile effect is to be generated, which tactile effect is to be generated, and where the tactile effect is to be generated.

In some embodiments the tactile effect generator 203 can be configured to receive and request information or data from the memory 205. For example in some embodiments the tactile effect generator can be configured to retrieve specific tactile effect signals from the memory in the form of a look up table dependent on the state of the tactile effect generator 203.

In some embodiments the apparatus comprises a memory 205. The memory 205 can be configured to communicate with the tactile effect generator 203. In some embodiments the memory 205 can be configured to store suitable tactile effect “audio” signals which when passed to the piezo amplifier 207 generates suitable haptic feedback using the tactile audio display.

In some embodiments the tactile effect generator 203 can output the generated effect to the piezo amplifier 207.

In some embodiments the apparatus comprises a piezo amplifier 207. The piezo amplifier 207 can be a single channel or multiple channel amplifier configured to receive at least one signal channel output from the tactile effect generator 203 and configured to generate a suitable signal to output to at least one piezo actuator. In the example shown in FIG. 3 the piezo amplifier 207 is configured to output a first actuator signal to a first piezo actuator 209, piezo actuator 1, and a second actuator signal to a second piezo actuator 211, piezo actuator 2.

It would be understood that the piezo amplifier 207 can be configured to output more than or fewer than two actuator signals.

In some embodiments the apparatus comprises a first piezo actuator 209, piezo actuator 1 configured to receive a first signal from the piezo amplifier 207 and a second piezo actuator 211, piezo actuator 2, configured to receive a second signal from the piezo amplifier 207. The piezo actuators are configured to generate a motion to produce the tactile feedback on the tactile audio display. It would be understood that there can be more than or fewer than two piezo actuators and furthermore in some embodiments the actuator can be an actuator other than a piezo actuator.

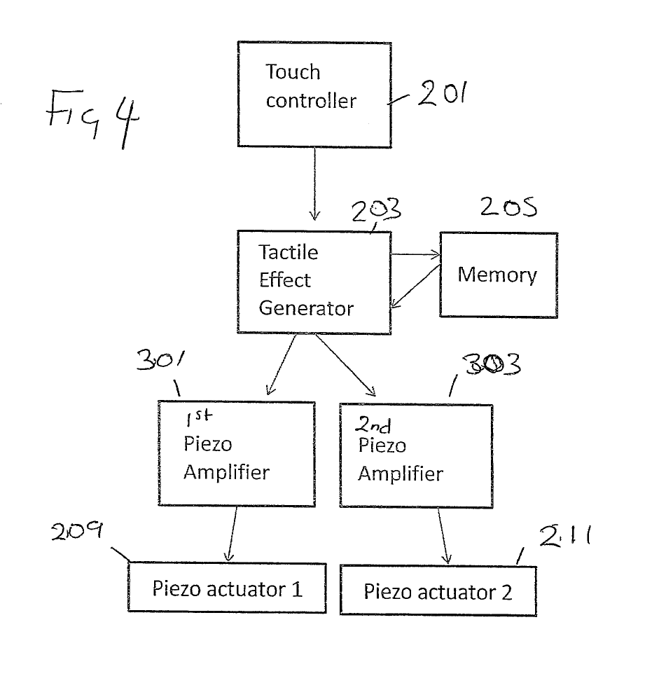

With respect to FIG. 4 the tactile effect generator system apparatus shown differs from the tactile effect generator system apparatus shown in FIG. 3 in that each piezo actuator is configured to be supplied a signal from an associated piezo amplifier. Thus for example as shown in FIG. 4 the first piezo actuator 209, piezo actuator 1 receives an actuation signal from a first piezo amplifier 301 and the second piezo actuator 211, piezo actuator 2 is configured to receive a second actuation signal from a second piezo amplifier 303.

With respect to FIG. 5 the tactile effect generator system apparatus shown differs from the tactile effect generator system apparatus as shown in FIG. 3 in that the tactile effect generator apparatus is configured to receive a further input from a force sensor 401.

In some embodiments therefore the tactile effect generator system apparatus comprises a force sensor 401 configured to determine the force applied to the display. The force sensor 401 can in some embodiments be implemented as a strain gauge or piezo force sensor. In further embodiments the force sensor 401 is implemented as at least one of the piezo actuators operating in reverse wherein a displacement of the display by the force generates an electrical signal within the actuator which can be passed to the touch controller 401. In some other embodiments the actuator output can be passed to the tactile effect generator 203. In some embodiments the force sensor 401 can be implemented as any suitable force sensor or pressure sensor implementation. In some embodiments a force sensor can be implemented by driving the piezo with a driving signal and then measuring the charge or discharge time constant of the piezo. A piezo actuator will behave almost like a capacitor when the actuator is charged with a driving signal. If a force is applied onto the display the actuator will bend and therefore the capacitance value of the actuator will change. The capacitance of the piezo actuator can be measured or monitored for example by a LCR meter and therefore the applied force can be calculated based on the capacitance change of the piezo actuator.

In some embodiments a special controller with functionality to drive and monitor at the same time the charge or discharge constant can be used to interpret the force applied on the display and therefore deliver the force values. This controller can thus in some embodiments be implemented instead of an separate force sensor as the actuator can be used the measure the force as described herein.

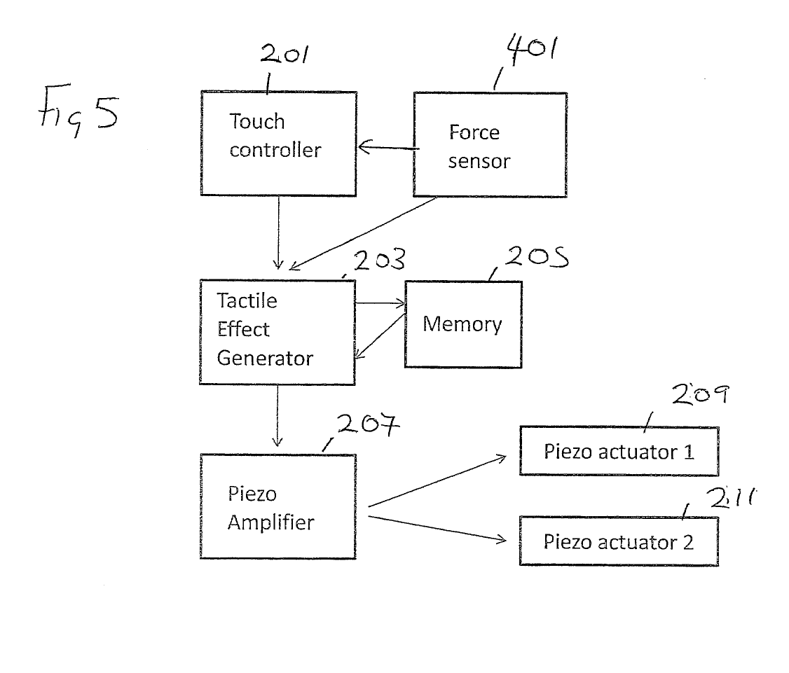

The tactile effect generator system apparatus as shown in FIG. 6 differs from the tactile effect generator system apparatus shown in FIG. 3 in that the tactile effect generator 203 in the example shown in FIG. 6 is further configured to generate not only tactile “audio” signals which are passed to the piezo actuator but configured to generate an audio signal which can be output to an external audio actuator such as the headset 501 shown in FIG. 6. Thus in some embodiments the tactile effect generator 203 can be configured to generate an external audio feedback signal concurrently with the generation of the tactile feedback or separate from the tactile feedback.

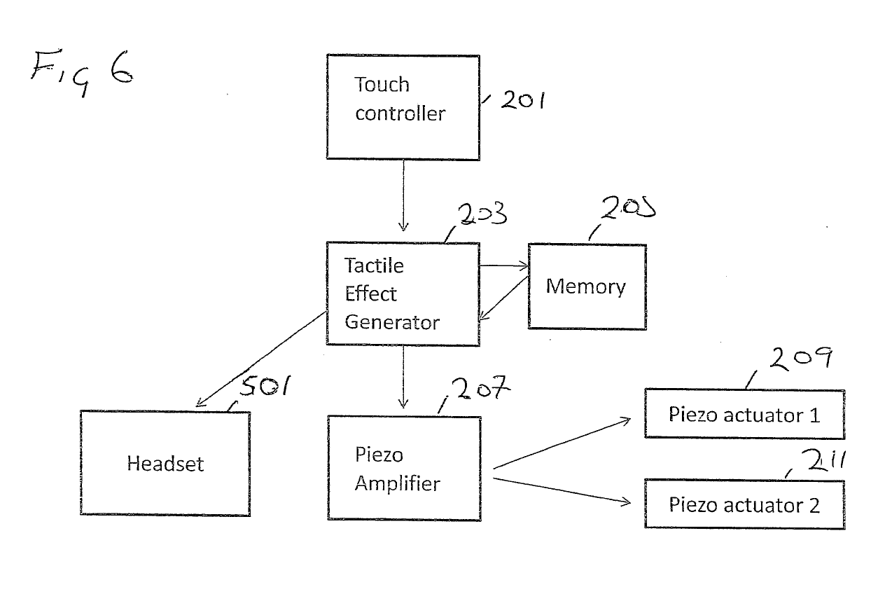

With respect to FIG. 7 an overview of the operation of the tactile effect generator system apparatus as shown in FIGS. 3 to 6 is shown with respect to some embodiments.

As described herein the touch controller 201 can be configured to receive the inputs from the touch screen and be configured to determine touch parameters suitable for determining tactile effect generation.

In some embodiments the touch controller 201 can be configured to generate touch parameters. The touch parameters can in some embodiments comprise a touch location, where the location of a touch is experienced. In some embodiments the touch parameter comprises a touch velocity, in other words the motion of the touch over a series of time instances. The touch velocity parameter can in some embodiments be represented or separated into a speed of motion and a direction of motion. In some embodiments the touch parameters comprise a pressure or force of the touch, in other words the amount of pressure applied by the touching object on the screen.

The touch controller 201 can then output these touch parameters to the tactile effect generator 203.

The operation of determining the touch parameters is shown in FIG. 7 by step 601.

In some embodiments the tactile effect generator 203 can be configured to receive these touch parameters and from these touch parameters determine a touch context parameter associated with the touch parameters.

Thus in some embodiments the tactile effect generator 203 can receive the location and analyse the location value to determine whether there is any tactile effect region at this location and which tactile effect is to be generated at the location. For example in some embodiments the touch screen may comprise an area of the screen which is configured to simulate a texture. The tactile effect generator 203 can having received the touch parameter location, determine which texture is to be experienced at the location. In some embodiments this can be carried out by the tactile effect generator 203 looking up the location from a tactile effect map stored in the memory 205.

In some embodiments the context parameter can determine not only the type of texture or effect to be generated but whether the texture or effect has directionality and how this directionality or other touch parameter dependency effects the tactile effect generation. Thus for the texture effect example the tactile effect generator 203 can be configured to determine whether or not the texture has directionality and retrieve parameters associated with this directionality. Furthermore in some embodiments the context parameter can determine whether the texture or effect has ‘depth-sensitivity’, for example whether the texture or effect changes the ‘deeper’ the touch is. In such embodiments the ‘depth’ of the touch can be determined as corresponding to the pressure or force of the touch.

The operation of determining the context parameters is shown in FIG. 7 by step 603.

The tactile effect generator 203 can, having determined the context parameters and receiving the touch parameters, generate tactile effects dependent on the context and touch parameters. For the texture example the tactile effect generator can be configured to generate the tactile effect dependent on the simulated texture and the touch parameters such as the speed, direction, and force of the touch. The generated tactile effect can then be passed to the piezo amplifier 207 as described herein.

The operation of generating the tactile effect depending on the context and touch parameters is shown in FIG. 7 by step 605.

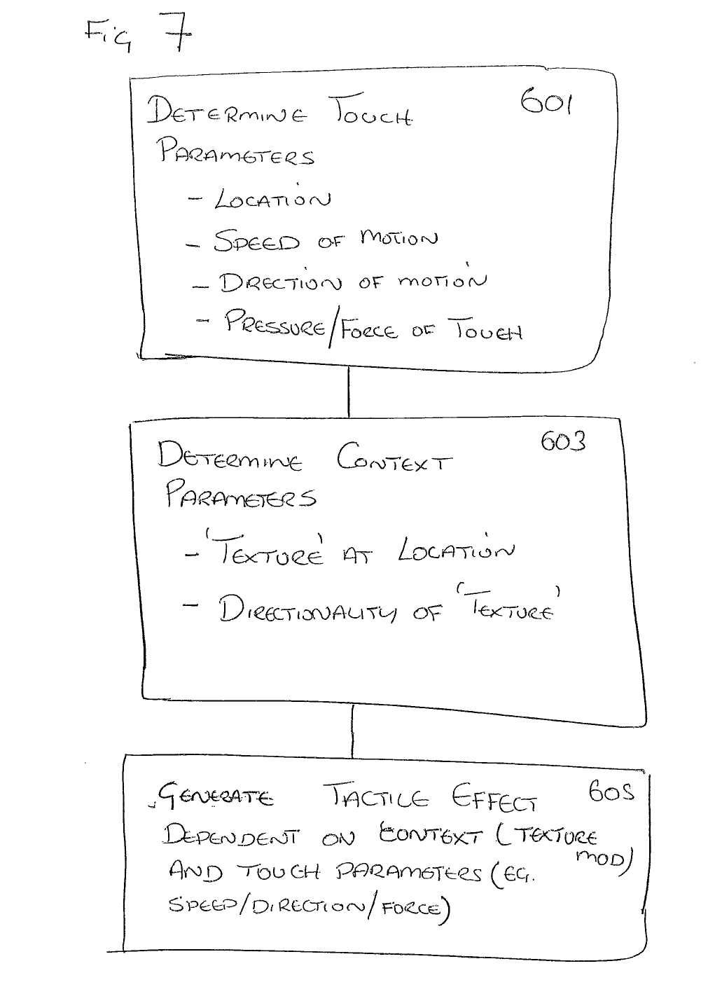

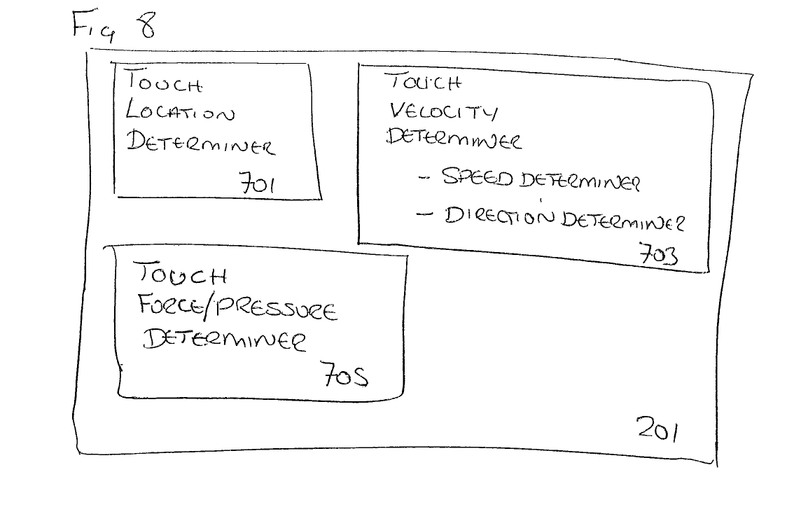

With respect to FIG. 8 an example touch controller 201 is shown in further detail. Furthermore with respect to FIG. 10 the operation of the touch controller according to some embodiments as shown in FIG. 8 is shown in further detail.

In some embodiments the touch controller 201 comprises a touch location determiner 701. The touch location determiner 701 can be configured to receive the touch inputs from the display and be configured to determine a touch location or position value. The touch location can in some embodiments be represented as a two (or three dimensional where pressure of force is combined) dimensional value relative to a defined origin point.

The operation of receiving the touch input is shown in FIG. 10 by step 901.

The operation of determining the touch location is shown in FIG. 10 by step 903.

The touch location determiner 701 can in some embodiments be configured to determine location values according to any suitable format. Furthermore the locations can be configured to indicate a single touch, or multi-touch locations relative to the origin or multi-touch locations relative to other touch locations.

In some embodiments the touch controller 201 can comprise a touch velocity determiner 703. The touch velocity determiner can be configured to determine a motion of a touch dependent on a series of touch locations over time. The touch velocity determiner can in some embodiments be configured to determine the touch velocity in terms of a touch speed and a touch direction component.

The operation of determining touch velocity from touch locations over time is shown in FIG. 10 by step 905.

In some embodiments the touch controller 201 comprises a touch force/pressure determiner 705. The touch force/pressure determiner 705 can be configured in some embodiments to determine an approximation of the force or pressure applied to the screen depending on the touch impact area. It would be understood that the greater the pressure the user applies to the screen the greater the touch surface area due to deformation of the fingertip under pressure. Thus in some embodiments the touch controller 201 can be configured to detect a touch surface area as a parameter which can be passed to the touch force/pressure determiner 705.

In some embodiments where the touch controller 201 receives an input from a force or pressure sensor such as shown in FIG. 5 by the force sensor 401, the touch controller 201 can be configured to use the sensor input to determine the contexts for the tactile effect generator 203. The tactile effect generator 203 can then be configured to generate simulated tactile effects dependent on the force/pressure input. For example a different simulated tactile effect can be generated dependent on the pressure being applied, so in some embodiments the more pressure or the greater the surface area of the fingertip sensed on the touch screen the greater the modification from the base signal used to generate the tactile effect.

The determination of the touch force/pressure determiner is shown in FIG. 10 by step 907.

In some embodiments the touch controller 201 can be configured to monitor not only the pressure or force exerted on the display but also the time period associated with the pressure. In some embodiments the touch controller 201 can be configured to generate a touch period parameter to the tactile effect generator 203 to generate tactile feedback dependent on the period of the application of the force.

The touch controller in the form of touch location determiner, touch velocity determine, and touch force/pressure determiner can then output these touch parameters to the tactile effective generator.

The operation of outputting the touch parameters to the tactile effect generator is shown in FIG. 10 by step 909.

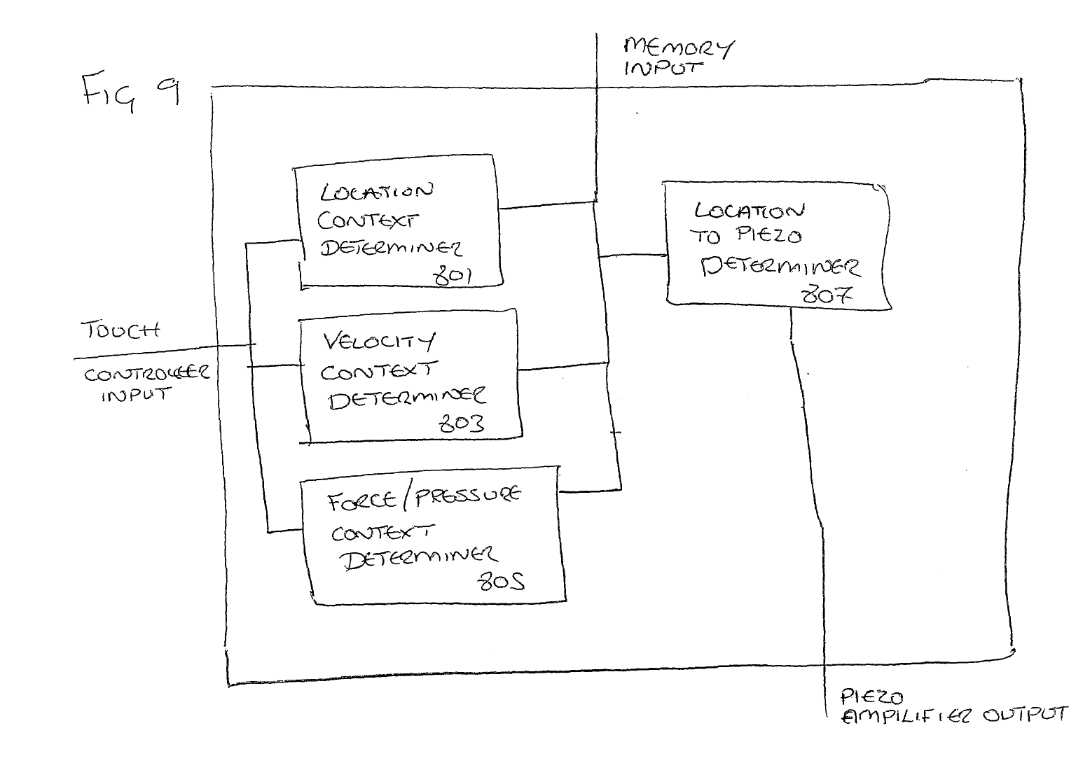

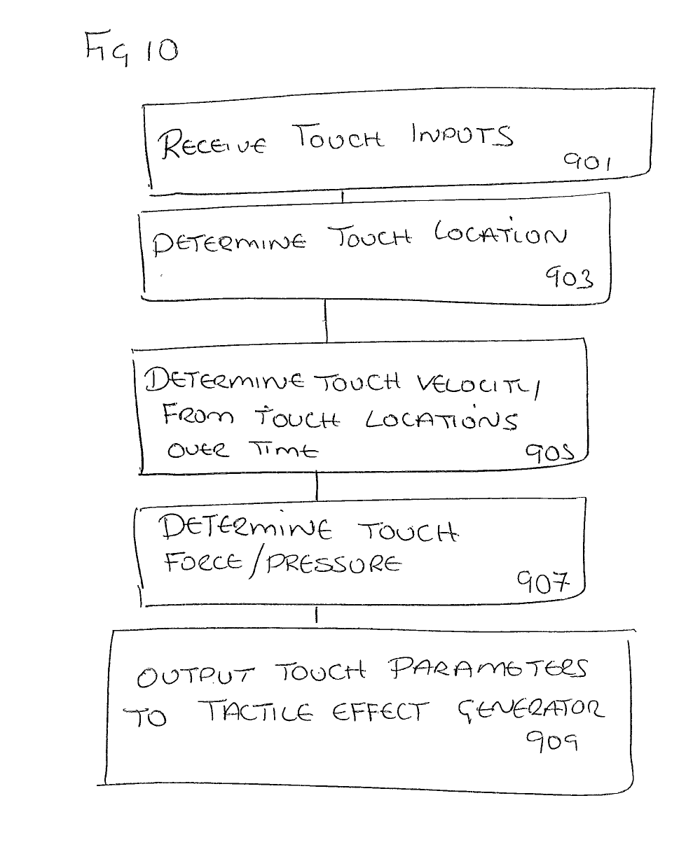

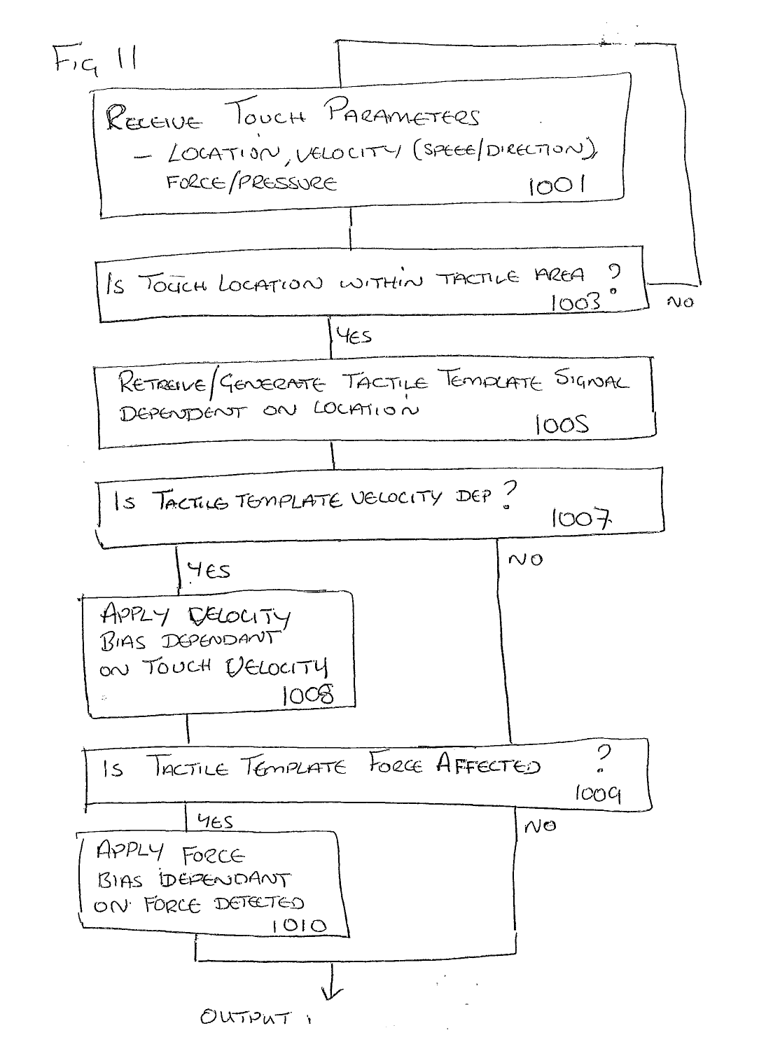

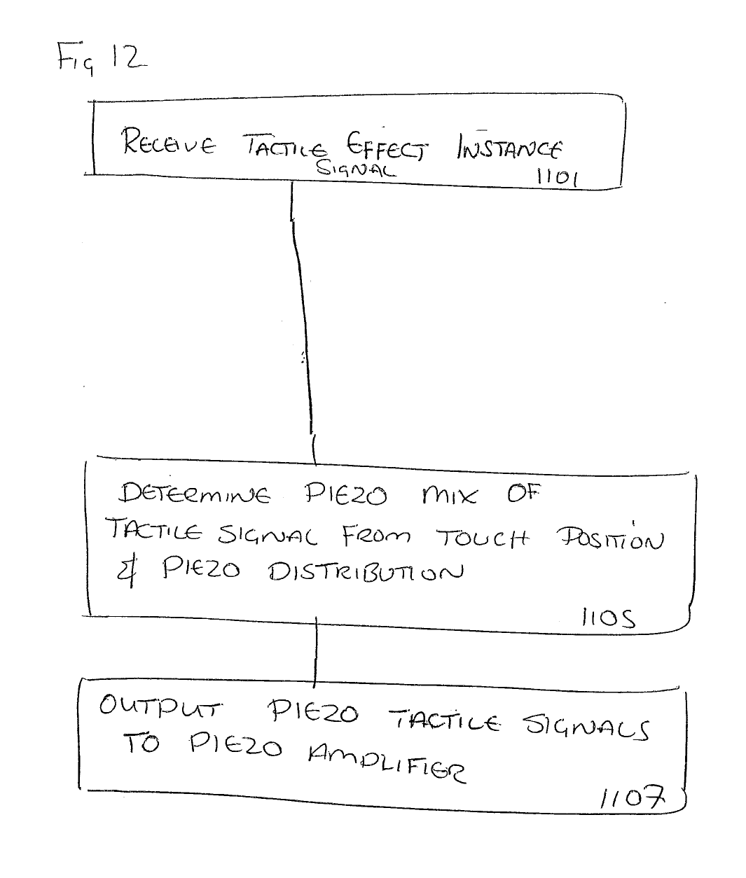

With respect to FIG. 9 an example tactile effect generator 203 is shown in further detail. Furthermore with respect to FIGS. 11 and 12 the operation with respect to some embodiments of the tactile effect generator 203 as shown in FIG. 9 is described in further detail.

In some embodiments the tactile effect generator 203 is configured to receive the touch parameters from the touch controller 201. The touch controller 201 as described herein can in some embodiments generate parameters such as location, velocity (speed and direction), period and force/pressure parameter data and pass the parameter data to the tactile effect generator 203.

The operation of receiving the touch parameters is shown in FIG. 11 by step 1001.

In some embodiments the tactile effect generator 203 can comprise a location context determiner 801. The location context determiner 801 is configured to receive the touch parameters, and in particular the location touch parameter and determine whether the current touch occurs within a tactile effect region or area. In some embodiments the tactile effect region can require more than one touch surface before generating a tactile effect, in other words processing a multi touch input.

The location context determiner 801 can thus in some embodiments determine or test whether the touch location or touch locations are within a tactile or context area.

The operation of checking or determining whether the touch location is within the tactile area is shown in FIG. 11 by step 1003.

Where the location context determiner 801 determines that the touch location is outside a tactile or context area in other words the touch is not within a defined tactile effect region then the location context determiner can wait for further touch information. In other words the operation passes back to receiving further touch parameters as shown in FIG. 11.

In some embodiments where the location context determiner determines that there is a specific context or tactile effect to be generated depending on the touch location (in other words the touch location is within a defined tactile effect region or area) then the location context determiner can be configured to retrieve or generate a tactile template or tactile signal depending on the location. In some embodiments the location context determiner 801 is configured to retrieve the tactile template or template signal from the memory. In some embodiments the location context determiner 801 can generate the template signal depending on the location according to a determined algorithm.

In the examples described herein the template or base signal is initialised, in other words generated or recalled or downloaded from memory dependent on the location and the template or base signal furthermore modified dependent on other parameters, however it would be understood that any parameter can initialise the tactile signal in the form of the template or base signal. For example the parameter which can initialise the template or base signal can in some embodiments be a ‘touch’ with motion greater than a determined speed, or a ‘touch’ in a certain direction, or any suitable combination or selection of parameters.

In some embodiments the tactile effect generator 203 comprises a velocity context determiner 803. The velocity context determiner 803 is configured to receive the touch controller velocity parameters such as the speed and direction of the motion of the touch. In some embodiments the velocity context determiner 803 can furthermore receive and analyse the tactile template or directional rules concerning the tactile effect area and determine whether the tactile effect is directional.

In some embodiments the velocity context determiner 803 can furthermore be configured to apply a speed bias to the base or template signal dependent on the touch speed.

The operation of determining whether the tactile template is directional or speed dependent is shown in FIG. 11 by step 1007. Where the tactile template is determined to be dependent on velocity parameters then the velocity context determiner 803 can be configured to apply a directional and/or speed bias dependent on the touch direction and/or speed provided by the touch controller velocity parameter.

The application of a directional and/or speed bias to the tactile template (tactile signal) is shown in FIG. 11 by step 1008.

Where the tactile template is not directional then the operation can pass directly to the force determination operation 1009.

In some embodiments the tactile effect generator 203 comprises a force/pressure context determiner 805. The force/pressure context determinator 805 is configured to receive from the touch controller touch parameters such as force or pressure touch parameters. Furthermore the force/pressure context determiner 805 can in some embodiments analyse the tactile effect template to determine whether the tactile effect being simulated has a force dependent element.

The operation of determining whether the tactile template is force affected is shown in FIG. 11 by step 1009.

Where the force/pressure context determiner 805 determines that the tactile template is force affected then the force/pressure context determiner 805 can be configured to apply a force bias dependent on the force parameter provided by the touch controller. It would be understood that in some embodiments the force parameter can be provided by any other suitable force sensor or module.

The operation of applying the force bias dependent on the force detected is shown in FIG. 11 by step 1010.

In some embodiments the tactile effect generator 203 comprises a location to piezo mapper or determiner 807 configured to receive the tactile effect signal which can in some embodiments be configured as a tactile effect instance and determine separate signals for each of the piezo transducers from the touch determined position, tactile effect signal distribution and the knowledge or information of the distribution of piezo-electric transducers in the display.

The operation of receiving the tactile effect signal is shown in FIG. 12 by step 1101.

The determination of the individual piezo electric transducer versions of the tactile effect signal is shown in FIG. 12 by step 1105.

Furthermore the location to piezo determiner 807 can then output the piezo-electric transducer signals to the piezo amplifier.

The output of the piezo-electric transducer tactile signals to the piezo amplifier is shown in FIG. 12 by step 1107.

With respect to FIGS. 13 to 21 a series of example simulated event tactile effects are shown. These simulated events are capable of being generated in some embodiments as described herein. The examples shown in FIGS. 13 to 21 specifically show the tactile effect simulation of a surface or material tactile effect where the surface of the display (for at least a portion of the display) simulates a surface effect other than that of flat plastic or glass. In other words the embodiments surface generates or “display” a haptic effect to the finger tip of the user when the finger is moved on the “simulated” surface.

In such embodiments the tactile effect template or tactile signal can be a short “preloaded” audio file or audio signal which can be output as a loop as long as the finger or touch is pressed and moved. Furthermore when the touch movement stops or finger is lifted then the tactile effect template audio file playback ends. In some embodiments the touch parameters can modify the audio file playback. For example the pitch or frequency of the audio file can be adjusted based on the finger or touch speed. In such embodiments the faster the speed of the touch then the tactile effect generator is configured to produce a higher pitch audio file and similarly a slower touch speed produces a lower pitch audio. This simulates the effect simulating the finger is on a textured surface and at different speeds where different frequency spectrums are produced. In other words the faster the touch movement over the simulated surface then the simulated sound has shorter wave lengths and therefore higher frequency components.

In some embodiments the volume or amplitude of the audio signal or tactile signal can be adjusted based on the touch speed. Thus the faster the speed, the louder the volume and the slower the speed, the lower the volume (with no movement producing zero volume). Thus once again the effect of moving a finger on a textured cloth in a quiet environment can be simulated where very slow movement produces very little sound and a faster movement produces greater or louder sounds.

An example texture or simulated surface is shown in FIG. 13. The textured surface 1201 as shown in FIG. 13 is a simulated cardboard or corrugated surface with a corrugation along a first (vertical) axis 1203. This corrugation is shown in FIG. 13 by the profile view 1205 showing a plot of the “simulated” height 1207 against the first axis 1203. The corrugation or cardboard effect can be simulated in some embodiments by a tactile signal (or audio signal) of a sinusoidal wave 1209 with a period T and an amplitude A. It would be understood that the template or tactile signal which simulates the surface or effect can be any suitable signal form or combination of signals.

Thus in some embodiments the cardboard simulated surface can be simulated by the location context determiner 801, having determined that the touch location 1211 is within the area defined as the cardboard surface retrieving the tactile effect template (the audio or tactile signal represented by the sinusoidal wave 1209) and pass the template to the velocity context determiner 803.

The velocity context determiner 803 can then in some embodiments be configured to analyse the template and modify or process the audio or tactile signal dependent on the speed of the touch such that the faster the speed of the touch (in the first axis 1203 along which the simulated corrugation occurs) the shorter the period (the higher the frequency) and the louder the volume (the greater the amplitude A) the audio signal becomes.

With respect to FIG. 14 the directionality aspect of the surface template is shown in further detail for the corrugated or simulated cardboard surface. As described herein the cardboard or corrugated surface 1201 is modelled as having a wave or sinusoidal like profile in a first axis shown in FIG. 14 by the axis 1303 but having none or only marginal profile differences in the second axis 1301 perpendicular to the first axis. Thus in some embodiments the cardboard surface is simulated so that more sound and frequency changes are felt when the finger is moved in the first axis (i.e. vertically) and less felt and heard when the finger is moved in the second axis (i.e. horizontally).

In such embodiments the velocity context determiner 803 can adjust the strength of the audio or tactile signal for the directions between purely horizontal and purely vertical. In some embodiments the horizontal and vertical angles of movement are normalised. In other words the audio signal is modified or changed by applying equal weights for the horizontal and vertical effect strengths for pitch and volume when moving the finger diagonally (or in any other angle in a straight line which produces the same amount of haptic effect).

In some embodiments the effect mixing or effect combining can be shown by the audio simulated signals shown for the vertical 1303, horizontal 1301 and diagonal 1302 motion where the diagonal 1302 motion has a lower amplitude and longer pitch (lower frequency) signal for a defined speed.

In some embodiments where a first audio signal or tactile signal is retrieved or generated to simulate motion for a first axis, for example the vertical axis 1303 and a second audio signal or tactile signal is retrieved of generated to simulate motion for a second axis, for example the horizontal axis 1301 then a movement not purely along the first or second axis (for example along the diagonal) causes the velocity context determiner 803 to generate a combined or mixed audio signal comprising a portion of the first audio signal associated with the first axis 1303 and a portion of the second signal associated with the second axis 1301. This mix or combination by any suitable means of first and second audio or tactile signal can be a linear or non-linear combination.

With respect to FIG. 15 an example simulated texture surface is shown. The simulated texture surface shown in FIG. 15 is a “leopard fur” or generic fur textured surface simulation. The “fur” surface simulation can in some embodiments provide an example where the simulation tactile signal is a first tactile or audio signal for a first direction 1401 along an axis and a second audio signal for the opposite direction 1403 along the same axis. Thus in some embodiments the context or tactile template can be directional along the same axis. Thus in some embodiments the fur textured simulation simulates the ability to “brush the fur the wrong way” and producing a “harsher” or higher frequency signal along a first direction than moving along the opposite way which would be considered to be brushing the fur in the correct way and producing a “smoother” or lower frequency signal.

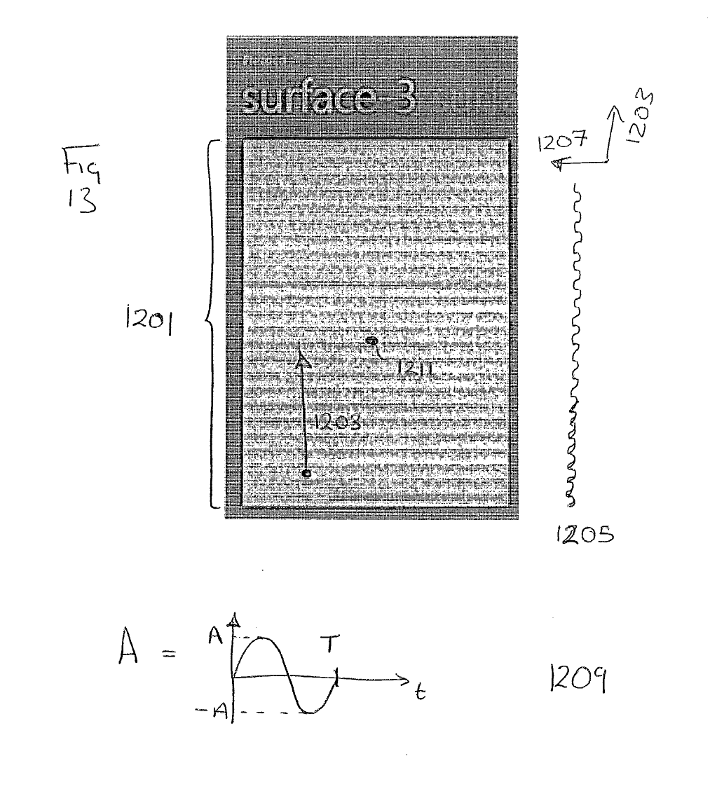

With respect to FIG. 16 a further example surface is shown. In FIG. 16 an “alien metal” surface is shown. In the examples shown in FIGS. 13, 14 and 15 the location context determiner 801 is configured to only determine whether the point of contact or touch impact is within the tactile region within which the audio signal or tactile signal is to be generated. However in some embodiments the location context determiner 801 can be configured to determine the “precise” point of the touch rather than a rough area determination and from this positional information modify the audio signal or tactile signal appropriately. Thus as shown in FIG. 16 the simulated surface is modelled with various levels of tactile profile changes and so dependent on the point of contact the location context determiner is configured to modify the tactile signal template or audio signal template to reflect the point of contact.

In some embodiments defects in a surface can be simulated and modelled in such a manner. Thus in some embodiments the location context determiner 801 can be configured to determine whether the point of contact is at a surface defect area and retrieve the audio signal or tactile signal for the defect or appropriately modify or process the non-defect surface audio signal or tactile signal according to a suitable defect processing.

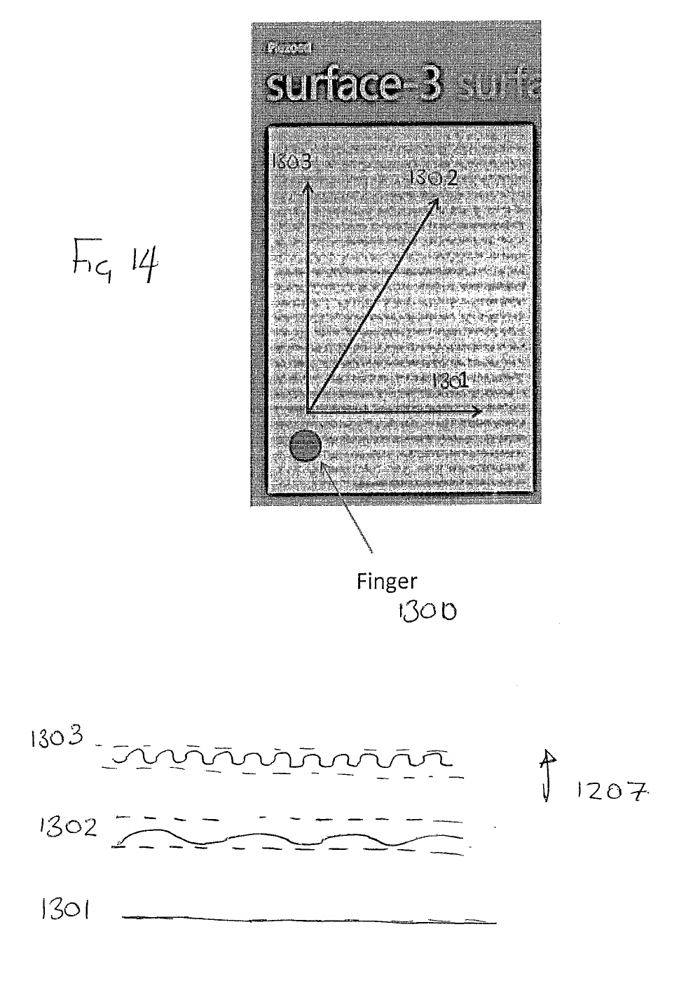

With respect to FIG. 17 a further example surface is shown. The example surface shown in FIG. 17 is one which has a first profile in other words a first audio signal or tactile signal along a first direction 1601 and a second profile (a second audio signal or tactile signal) along a second perpendicular direction 1603. As described herein the velocity context determiner 803 can be configured to determine and combine the two directional audio signals or tactile signals depending on the direction of touch A and B motion relative to the first direction 1601 and the second direction 1603. This combination can as described herein be linear [e.g. Aθ+B (90−θ) where A and B are the first and second signals and θ the cosine of the direction of movement] or non-linear [e.g. Aθ²+B (90−θ)²].

With respect to FIG. 18 a further example surface is shown. The example surface shown in FIG. 18 is that of a soapy glass surface. The soapy glass surface is modelled as a glass window with some soap on it. The location context determiner 801 is configured to determine whether the point of contact is within the modelled or simulated soapy glass area and generate a suitable audio signal (tactile signal). In some embodiments the location context determiner 801 is configured to generate not only a tactile (audio) signal for outputting by the tactile audio display via the piezo electric transducers but also a suitable audio signal which can be output by a conventional transducer or via headphones, headsets or earpieces.

Furthermore although the image shown in FIGS. 13 to 21 are static it would be understood that in some embodiments the image could change as the finger moves over the surface. In some embodiments for example the image could mix or smudge the content of the screen. Similarly in some embodiments the surface can be configured to generate an animated image when it is determined that the finger is moving along the textured surface. Thus for example the ‘soap’ image can be smeared over the glass surface. Any interaction would change the appearance of the image and furthermore change the haptic reaction map, so that the haptic reaction generated by swiping a finger over the area a first time would be different from when the user swipes a second time over the same surface. Furthermore in some embodiments the dynamic type haptic effect generated by the dynamic texture map can be a temporary change effect, in other words able to be further changed such as for example the ‘soap’ image. In some embodiments the dynamic type haptic effect generated by the dynamic texture map can be a permanent change effect, where the change cannot be further modified. An example of a permanent change effect would be a ‘broken’ glass effect where the display can have a first texture map (unbroken) and after a determined force value is detected has a second texture map (broken).

These dynamic type haptic effects can be applied to any suitable haptic response and image. For example the dynamic haptic reaction map can be implemented for sand ‘surfaces’ as described herein. In some embodiments the dynamic haptic reaction map can in some embodiments change directional haptic responses. For example a fur ‘surfaces’ would have an appearance and haptic reaction map when the fur′ is brushed in one direction and a further appearance and haptic reaction map for parts where the fur′ is brushed in another or wrong direction. In other words the look and ‘feel’ of the hair forming the fur can in some embodiments be modified and when you brush a second time over the same area. These dynamic haptic reaction map and image modification can be applied to other ‘texture’ or ‘fibre’ based effects. For example a carpet surface with long fabric “hair” or shagpile can be simulated by dynamic haptic maps and images. Another example of a simulated surface which could be simulated would be a grassy or turfed surface effect which could be simulated with a texture which changes appearance when someone swipes over it.

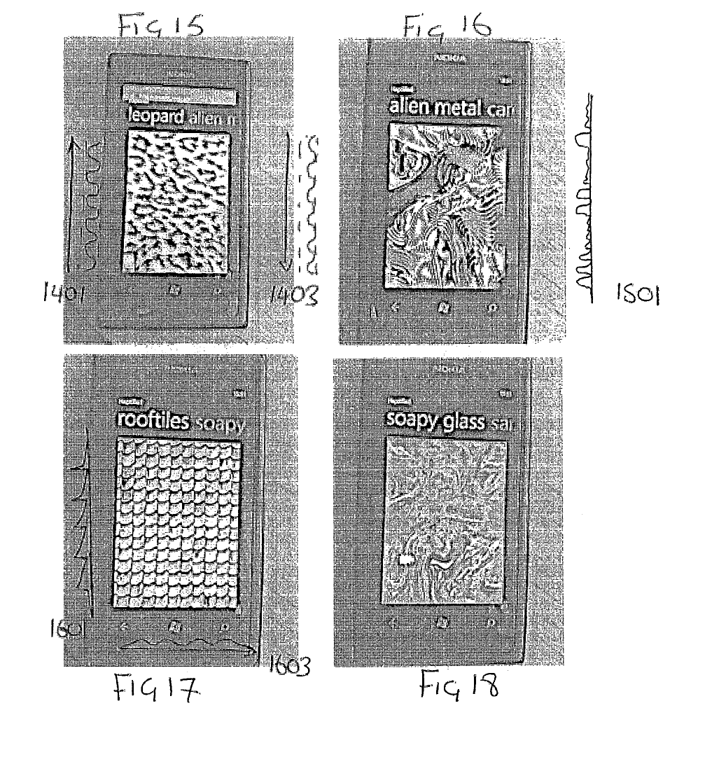

With respect to FIG. 19 a further example surface is shown. The example surface shown in FIG. 19 is that of a sandy or sand bed surface. The surface shown in FIG. 19 can in some embodiments be modelled such that as well as speed and direction are simulated that the force or pressure applied by the touch, being detected by the force/pressure context determiner 805, is configured to modify the audio signal or tactile signal in suitable manner. For example the greater the pressure or (force) then the audio or tactile signal is modified to have a greater volume and lower tone thus simulating a ‘depth effect’ or digging or “digging in” effect on the surface. Furthermore the surface show in the example of FIG. 19 that the directional context can vary across the simulated surface as can be seen by the wave or profile troughs at the top edge of the surface 1701 which have a different frequency and direction when compared to the wave or profile troughs shown at the bottom of the image 1703. In such embodiments the audio signal or tactile signal can thus have directionality which varies about the surface.

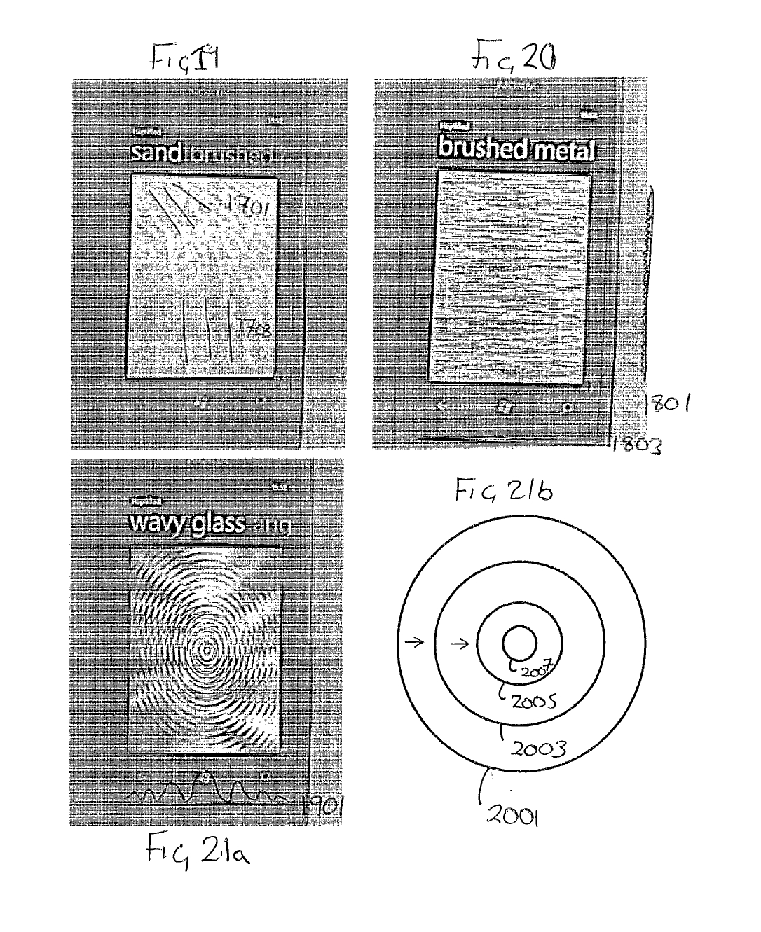

With respect to FIG. 20 a further example surface is shown. The example surface shown in FIG. 20 is that of a brushed metal surface. The brushed metal surface is similar to the cardboard surface with a directionality which is shown on a first axis 1801 compared to the second axis or perpendicular axis 1803, but with a much higher frequency wave form audio or tactile signal than the cardboard template audio signal or tactile signal.

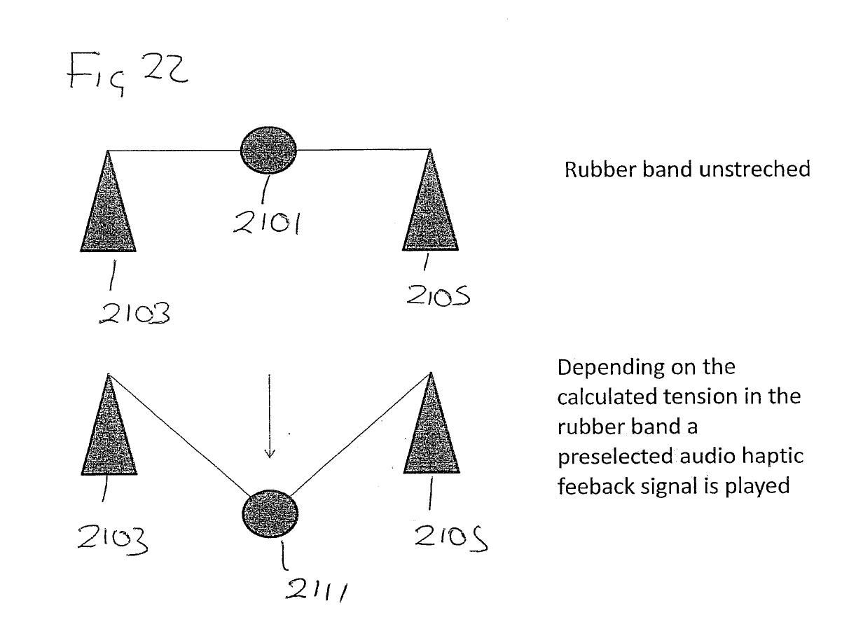

With respect to FIG. 21a a further example surface is shown. The example surface shown in FIG. 21a shows a “wavy glass” surface. The wavy glass surface is modelled such that the amplitude of the simulated audio or tactile waves are not only velocity based but location based. In other words as the finger or touch is moved over the centre of the image the feedback is stronger than that experienced at the corners. In other words the amplitude of the tactile signal is dependent on the position of the touch.

With respect to FIG. 21b an example implementation is shown wherein the wavy glass is modelled as a series of concentric circular areas, an outer area 2001, a first inner area 2003, a second inner area 2005 and a central area 2007. In such embodiments there can be a separate audio signal or tactile signal template for each area in other words an outer area signal, a first inner area signal, a second inner signal and a central area signal respectively. In some embodiments the location context determiner 801 can amplify the template audio or tactile signal dependent within which area the touch impact is determined, in other words that the tactile signal has an outer area gain, a first inner area gain, a second inner area gain and a central gain respectively applied to the base or template audio or tactile signal.

It would be understood that in some embodiments the touch location and velocity information can be stored within a single data structure. In some embodiments the processing of the audio signal is performed depending on a similar data structure which contains the static relative position and frequency volume modification factors at that point. An indicator indicating that the current point of contact is within the modelled area can for example be a value flag.

In such embodiments a function can be used to get the modification value, the number of the points on the list which would normally be 3 to 10 depending on the complexity and size of the texture area then interpolate values between these defined points. Where there are more defined points then the structure becomes more detailed however more data is required to be stored. In some embodiments it would be understood that the modification points can be defined such that they occur in greater frequency nearer the centre of the area and are sparse at the edges or the periphery of the areas.

Similarly there may be dynamical rules which are controlled by a function which gets the velocity factors for all axis to set the feedback signal re-sampling speed and similarly a function which gets the volume factors for all the axis to set the playback volume. In such embodiments the touch data structure and sample mod output pointers are, the final factors are calculated using statistical and dynamical rules, the factor values are stored to a structured output.

Then the final signal handling is performed by a function. In some embodiments the selection of the surface wave file to be played in the loop mode is selected and further the area can be determined to receive touch data.

In some embodiments the texture audio signals or tactile effect signals are preferred to be short files in order that the response and accuracy time is reasonable.

In some embodiments tactile effects can be implemented with regards to multi touch user interface inputs.

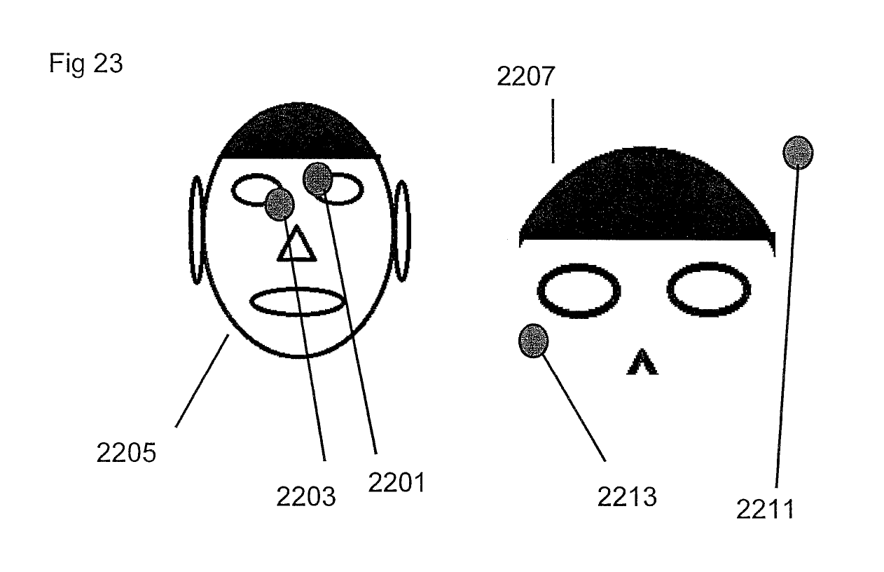

With respect to FIG. 23 an example of such a multi-touch user interface tactile effect is shown. In this “pinch and zoom” example an example image 2205 has initial finger or touch positions 2201 and 2203 located on it. The touch positions are moved apart as “pinch and zoom” gesture. The location context determiner 801 can be configured to determine the displacement between the touch positions and retrieve and process a tactile signal or audio signal to generate a tactile effect used to model “a tension” which the touch position movement is causing from the initial touch position distance to the zoomed touch distance, in other words to haptify a pinch and zoom gesture using a tactile effect similar to that of an elastic band stretch (as described herein later) i.e. increasing tone as the distance increase. This can be seen in the second image showing a zoomed in image section where the touch positions 2213 and 2211 which are the displaced initial touch positions 2203 and 2201 respectively are further apart. In such embodiments as the displacement between the touch positions increase then the tactile or audio signal can be modified for example by modifying the tactile signal to have an increasing tone and volume.

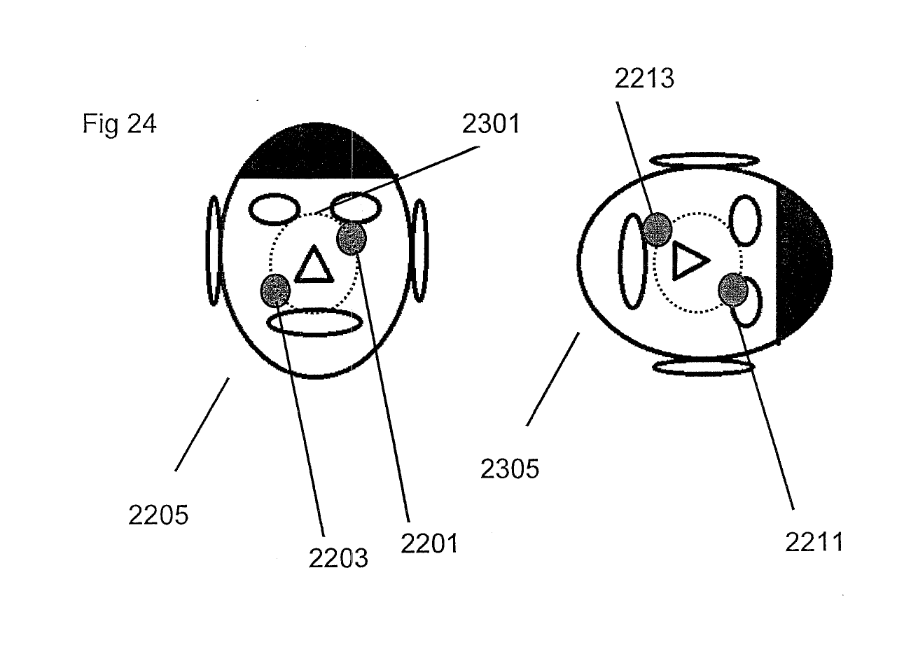

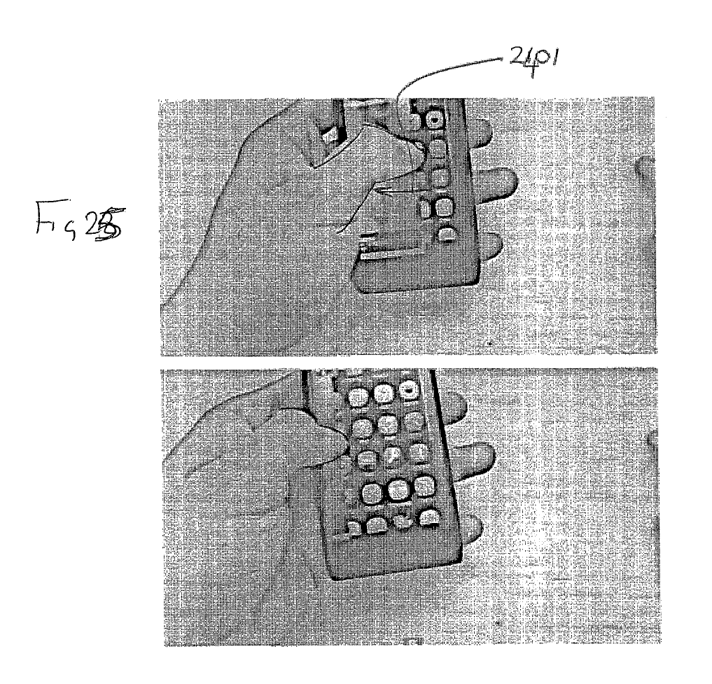

With respect to FIG. 24 a further multi-touch user interface tactile effect example is shown. In FIG. 24 a “rotate” gesture user interface haptification can be seen wherein the example image 2205 and initial touch positions 2201 and 2203 are shown. A rotational displacement of the touch positions can in some embodiments cause the location context determiner 801 to generate a suitable haptic or tactile signal depending on the angle of displacement from the initial touch position orientation. This is shown in FIG. 24 where the touch positions 2311 and 2313 and the rotated image 2305 would be detected and the orientation displacement cause the location or velocity context determiner to generate a tactile signal or an audio signal dependent on a “case” or template signal modified with respect to the determined orientation displacement. In some embodiments the modification to the base or template signal can depend on the touch position “diameter” with the intensity of the haptic feedback increased the greater the diameter. Thus in some embodiments the larger the diameter, the greater the haptic feedback for a defined rotation or orientation displacement occurs.

In some embodiments the location context determiner 801 can further be configured to determine when the touch position rotation is close to a defined rotation angle, (such as 90 degrees or π/2 radians) and generate a further haptic feedback as the image “snaps” into its rotated position. In some embodiments a snap feedback can be also generated by using a short “snap” pulse generated by a vibra motor. Similarly in some embodiments it would be understood that additional kinetic effect can be generated by using the vibra motor to enhance the piezo actuator effect. Thus for example in some embodiments an additional vibra pulse can be implemented to add kinetic effects for the rotation feature and for the pinch and zoom gesture.

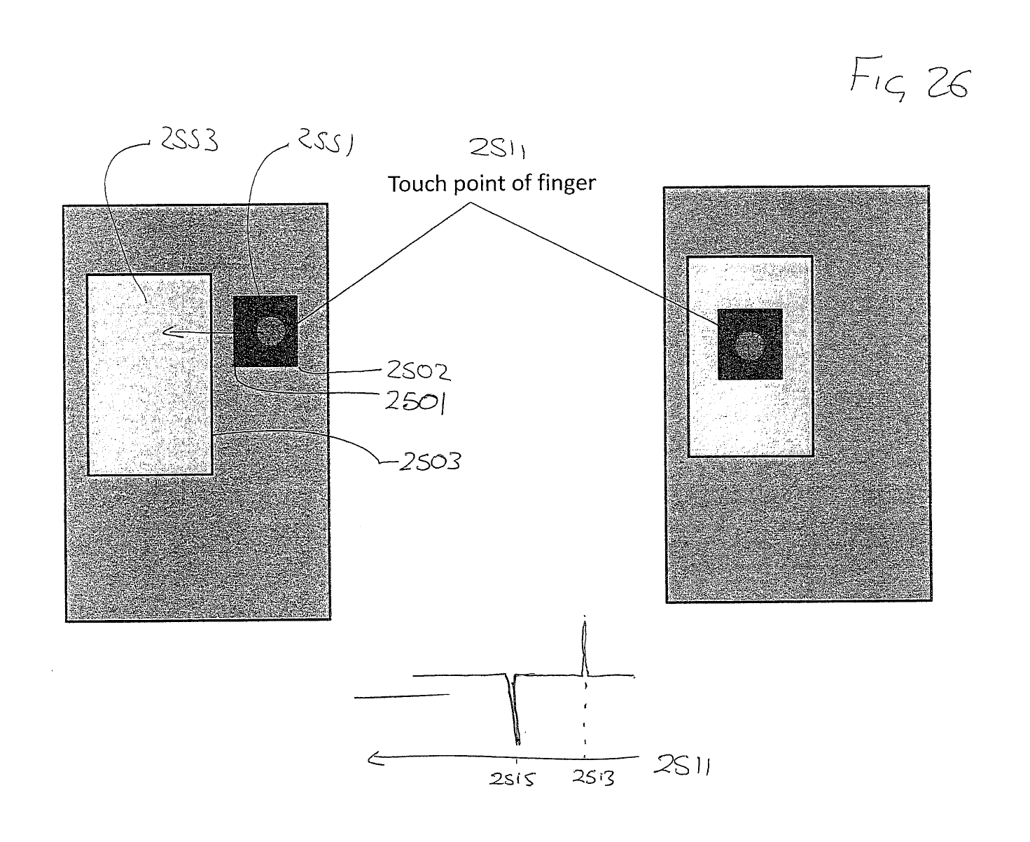

With respect to FIG. 25 a further user interface touch or tactile effect is shown by two images of a “swiping gesture”. The location context determiner 801 can in some embodiments be configured to generate a tactile of audio signal depending on the displacement or velocity of the swipe 2401 as the touch point or position, which is shown in FIG. 25 as the thumb, moves horizontally across the screen swiping an image or “canvas” away.

Furthermore in some embodiments the location context determiner 801 can be configured to generate a further haptic feedback signal when the canvas in other word the displayed image snaps into a final position. As described herein in some embodiments additional kinetic effect can be generated by using generating a vibra pulse from a vibra in combination with the piezo actuator effect.

A similar feedback could be implemented for page turning or book reader application when pages are flipped. In other words the location context determiner 801 can be configured to determine when the touch point moves across the screen sufficiently to turn the page and generate an audible and haptic feedback.

In some embodiments the haptic feedback can be configured to simulate a drag and drop gesture. This is shown in FIG. 26 where a point of contact 2511 presses on the image of a first box which is then dragged and dropped into a second box 2553.

In some embodiments as the touch point 2511 moves the first box 2551 such that the leading edge 2501 touches the leading edge of the second box 2553 then a haptic signal is generated shown in the profile 2511 as the first click 2513.

Furthermore when the following edge 2502 of the first box 2551 passes the leading edge of the second box then the location context determiner 801 can be configured to generate a further haptic feedback shown by the second downwards click 2515 on the profile 2511. Thus in some embodiments a haptic or tactile signal can provide feedback as the finger is moving objects into an acceptable area. In some embodiments the haptic feedback can be configured to simulate a drag and drop gesture in such a way that the movement of a selected item can provide feedback even where no other item is touched by the selected item as it is moved. In such embodiments dragging the item can provide a first feedback signal and collisions with other items when dragged can provide additional feedback signals.

It would be understood that other user interface gestures can be simulated such as scrolling, which can be simulated in a similar manner to swiping and holding a button which can be simulated in a manner similar to drag and drop. In some embodiments clicking a browser link can generate a suitable tactile signal where touching the browser link causes a haptic reaction (where a suitable audio or tactile signal is generated and output to the display so that a person can feel the browser links as the finger is swiped over a link. In some embodiments different types of link can be configured to generate different tactile feedback. Thus for example an unclicked link may differ from a previously clicked link; a mailto link may differ from a http:/link and a https:/link. Furthermore in some embodiments a previously clicked or touched link can produce a different feedback signal to a new or untouched link. Furthermore it would be understood that applications other than browsers can be configured with ‘touch sensitive’ areas which display images where touch parameters are determined and the haptic profile map controls the generation of a suitable display haptic effect when ‘touched’ in a suitable way.

Thus in some embodiments both the tactile and audio feedback of a simulated object that is being “touched” can depend on the simulated material of the object and the force that the object is touched with. Similarly the tactile and audio feedback of an object that is handled can dependent on the material of the object, the temperature of the object, how much the object has been stretched and what object is the object attached to.

Both the tactile and audio feedback of object that interact can in some embodiments depend on the simulated material and shape of the object and the simulated temperatures of the object.

Thus for example there can be different tactile signals from different “parts” of the object simulating where the object is touched. In addition to the simulation (or mimicking) of object there can be a tactile effect generated with respect to purely artificial objects such as scroll bars, text editors, links and browsers. Thus whenever the device UI detects a UI element or some other object that the user can interact with, for an example an object in a game or a picture in a text editor, then the tactile and audio feedback can depend on various parameters such as force, physical properties of the object, the physical properties of the environment that is presented with the UI and whatever objects the object is attached to.

An example of which include a simulation of a wooden object. The simulated object would give different tactile and audio feedback than touching a simulated metal object. Similarly if an object within a game can be simulated where the tactile and audio feedback differs when the object is touched using a strong force from touching it gently. In some embodiments the object can be characterised by a simulated feature such as temperature and thus moving the touch position on a metal object of simulated +20° C. temperature in a game may give a different tactile and audio feedback than moving a finger on top of a simulated metal object with a simulated −20° C. temperature.

Stretching a rubber band in a game may give a different tactile and audio feedback depending on how much the band has been stretched. Furthermore moving a simulated object in “simulated” air may give a different tactile and audio feedback from moving the simulated object so that it touches the “simulated” ground or simulated as being under water or in a different liquid.

With respect to FIG. 22 a further example tactile effect which can be generated according to some embodiments is shown. The tactile effect simulates a resilient or spring (or elastic band) effect for a position on the display surface. An example of which is the rubber band effect shown in FIG. 22. It is known that a rubber band or spring being stretched produces an audio sound where the greater the tension produced by the more the band is tightened or pulled the higher the pitch of the vibrations of the band.

In other words the greater tension in the spring or band the higher the frequency of the audio or tactile produced. Thus a simulated (or point of touch) mass 2101 on a rubber band in a rest or un-stretched between two points of contact 2103 and 2105 can in some embodiments produce no initial sound or an audio or tactile signal with no or significantly no amplitude or volume.

However as the point of touch or simulated mass, is moved from the rest position then the simulated tension in the band can be experienced by outputting an audio or tactile signal with a volume and tone based on the stretch and the audio or tactile signal based on the stretch can be passed to the piezo electric actuators to generate a suitable “rubber band” tactile feedback.

In such embodiments the location context determiner 801 can determine the location of the touch point 2111 the tensioned position compared to the “resting position” or initial point of touch 2101 and the audio or tactile signal processed depending on this displacement in the manner as described herein.

In some embodiments as described herein the frequency of the audio or tactile signal increases as the touch displacement distance from the initial touch increases. In some embodiments it would be understood that rather than processing a template audio signal then one audio or tactile signal from a group of audio or tactile signals is selected. For example there can in some embodiments be stored in the memory a number of signals of increasing frequency. In such embodiments one of these signals are selected dependent on the displacement from the rest position and the signal passed to the piezo amplifier output. Such embodiments may require less processing but require greater memory storage storing multiple template audio signals. In some embodiments a combination of both dynamic pitch shifting (frequency processing with respect to the displacement) with different preloaded effects can also be implemented to provide a range of different haptic effects with smooth transitions.

In some embodiments tactile effects associated with stretching a resilient body such as a spring or elastic band as shown herein can be implemented with regards to multi touch user interface inputs.

In some embodiments the context can be a collision context which is furthermore dependent on the characterising of the objects. In other words when two simulated objects hit each other the tactile and audio feedback may be different if both of the objects are of metal compared to when than one of the simulated objects is metal and the other simulated object is of a different substance such as glass.

In some embodiments the tactile effect context can be related to the position on the display. Thus for example dropping at one position could generate a first feedback and dropping at a second position generate a second feedback.

In some embodiments a context can be related to the speed or direction of the dragging or movement. In some embodiments the context can depend on any display elements underneath the current touch position. For example when moving an object across a screen any crossing of window boundaries could be detected and the tactile effect generator 203 generate a tactile feedback on crossing each boundary. Furthermore in some embodiments the boundary can be representative of other display items such as buttons or icons underneath the current press position.

In some embodiments the tactile effect generator 203 can be configured to generate tactile effect haptic feedback for scrolling. The scrolling operation can be consider to be similar to a slider operation in two dimensions. For example where a document or browser page or menu does not fit a display then the scrolling effect has a specific feedback when reaching the end of the line and in some embodiments moving from page to page or paragraph to paragraph. The feedback can in some embodiments depend on the scrolling speed, the direction of the scrolling and what is occurring underneath the scrolling position. For example in some embodiments the touch controller 201 and tactile effect generator 203 can be configured to generate tactile control signals based on any display objects which disappear or reach the edge of the display as the touch controller 201 determines the scrolling motion.

Although in the embodiment shown and described herein are single touch operations, it would be understood that the tactile effect generator 203 can be configured to generate tactile effects based on multi-touch inputs.

For example the tactile effect generator could be configured to determine feedback for a zooming operation where two or more fingers and the distance between the fingers define a zooming characteristic (and can have a first end point and second end point sector divisions). Similarly multi-touch rotation where the rotation of the hand or fingers on the display can have a first end point, a second end point, and rotation divisions and be processed emulating or simulating the rotation of a knob or dial structure.

In some embodiments drop down menus and radio buttons can be implemented such that they have their own feedback. In other words in general all types of press and release user interface can have their own feedback associated with them. Furthermore in some embodiments hold and move user interface items can have their own feedback associated with them.

It shall be appreciated that the term user equipment is intended to cover any suitable type of wireless user equipment, such as mobile telephones, portable data processing devices or portable web browsers. Furthermore, it will be understood that the term acoustic sound channels is intended to cover sound outlets, channels and cavities, and that such sound channels may be formed integrally with the transducer, or as part of the mechanical integration of the transducer with the device.

In general, the design of various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The design of embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory used in the design of embodiments of the application may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be designed by various components such as integrated circuit modules.

As used in this application, the term ‘circuitry’ refers to all of the following:
(a) hardware-only circuit implementations (such as implementations in only analogy and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-22. (canceled)

23. A method comprising:
determining a haptic profile map for a display;
determining a touch event on the display within the area defined by the haptic profile map; and
generating a haptic effect on the display based on the touch event such that the haptic effect provides a simulated surface experience.

24. The method as claimed in claim 23, wherein determining the haptic profile map comprises at least one of:
generating the haptic profile map for the display; and
loading the haptic profile map for the display.

25. The method as claimed in claim 23, wherein the haptic profile map comprises at least one of:
at least one base haptic signal;
at least one displacement signal modification factor;
at least one directional signal modification factor;
a speed signal modification factor;
a touch period modification factor; and
a force signal modification factor.

26. The method as claimed in claim 23, wherein determining the touch event comprises at least one of:
determining at least one touch position;
determining at least one touch direction;
determining at least one touch speed;
determining at least one touch period; and
determining at least one touch force.

27. The method as claimed in claim 23, wherein determining the haptic profile map comprises determining the haptic profile map dependent on a previous touch event.

28. The method as claimed in claim 23, wherein determining the touch event comprises determining at least one of:
a hover touch over the display; and
a contact touch physically in contact with the display.

29. The method as claimed in claim 23, further comprising displaying an image on the display, wherein determining the haptic profile map for the display comprises determining the haptic profile map associated with the image.

30. The method as claimed in claim 29, further comprising modifying the image on the display dependent on the touch event on the display.

31. The method as claimed in claim 23, wherein generating the haptic effect on the display comprises at least one of:
actuating the display by at least one piezoelectric actuator located underneath and in contact with the display; and.
actuating an apparatus comprising the display by at least one vibra actuator located within the apparatus

32. The method as claimed in claim 31, further comprising generating an acoustic effect on the display based on the touch event such that the acoustic effect further provides the simulated surface experience.

33. An apparatus comprising at least one processor and at least one memory including computer code for one or more programs, the at least one memory and the computer code configured to with the at least one processor cause the apparatus to at least:
determine a haptic profile map for a display;
determine a touch event on the display within the area defined by the haptic profile map; and
generate a haptic effect on the display based on the touch event such that the haptic effect provides a simulated surface experience.

34. The apparatus as claimed in claim 33, wherein the determined haptic profile map causes the apparatus to at least one of:
generate the haptic profile map for the display; and
load the haptic profile map for the display.

35. The apparatus as claimed in claim 33, wherein the haptic profile map comprises at least one of:
at least one base haptic signal;
at least one displacement signal modification factor;
at least one directional signal modification factor;
a speed signal modification factor;
a touch period modification factor; and
a force signal modification factor.

36. The apparatus as claimed in claim 33, wherein the determined touch event causes the apparatus to at least one of:
determine at least one touch position;
determine at least one touch direction;
determine at least one touch speed;
determine at least one touch period; and
determine at least one touch force.

37. The apparatus as claimed in claim 33, wherein the generated haptic effect on the display causes the apparatus to at least one of:
actuate the display by at least one piezoelectric actuator located underneath and in contact with the display; and.
actuate the apparatus comprising the display by at least one vibra actuator located within the apparatus

38. The apparatus as claimed in claim 37, wherein the apparatus is further caused to generate an acoustic effect on the display based on the touch event such that the acoustic effect further provides the simulated surface experience.

39. An apparatus comprising:
a haptic profile determiner configured to determine a haptic profile map for a display;
a touch event determiner configured to determine a touch event on the display within the area defined by the haptic profile map; and
a haptic effect generator configured to generate a haptic effect on the display based on the touch event such that the haptic effect provides a simulated surface experience.

40. The apparatus as claimed in claim 39, wherein the haptic effect determiner comprises at least one of:
a haptic profile map generator configured to generate the haptic profile map for the display; and
a haptic profile map input configured to load the haptic profile map for the display.

41. The apparatus as claimed in claim 39, wherein the haptic profile map comprises at least one of:
at least one base haptic signal;
at least one displacement signal modification factor;
at least one directional signal modification factor;
a speed signal modification factor;
a touch period modification factor; and
a force signal modification factor.

42. The apparatus as claimed in claim 39, wherein the touch event determiner comprises at least one of:
a touch position determiner configured to determine at least one touch position;
a touch direction determiner configured to determine at least one touch direction;
a touch speed determiner configured to determine at least one touch speed;
a touch duration timer configured to determine at least one touch period; and
a touch force determiner configured to determine at least one touch force.
